(19) United States
(12) Patent Application Publication
(10) Pub. No.: US 2004/0256929 A1
(43) Pub. Date: Dec. 23, 2004

(54) Tubular flywheel energy storage system

(76) Inventors: Christopher W. Gabrys, Reno, NV (US); David R. Campbell, Reno, NV (US)

Correspondence Address: J Michael Neary, Neary Law Office, 542 SW 298th Street, Federal Way, WA, 98023, US

(21) Appl. No.: 10/488,349

(22) PCT Filed: Aug. 30, 2002
(86) PCT No.: PCT/US02/27781

Related U.S. Application Data
(60) Provisional application No. 60/317,732, filed on Aug. 30, 2001.

(51) Int. Cl. H02K 7/02

(52) U.S. Cl. 310/74

(57) ABSTRACT

A flywheel energy storage system has a tubular cylindrical steel flywheel rim that spins, with a peripheral speed greater than 200 meters per second in normal, fully charged operation, about a vertical axis inside an evacuated chamber for energy storage and retrieval. The steel rim is heat treated to a tensile yield strength greater than 100 ksi and plane strain fracture toughness in the hoop direction greater than 70 ksi(in)^{1/2}. A motor generator is coupled to the flywheel for accelerating the angular velocity of the flywheel for storage of energy, and for converting angular inertial of the flywheel back into electrical energy. The motor/generator may include an assembly of permanent magnet pieces substantially filling the circumference of the inner diameter of the flywheel rim. The magnet pieces are radially magnetized and the magnet assembly forms a dipole field across the inner diameter of the magnetic assembly with magnetic flux traveling from the outer diameter of the magnets in the assembly through the steel rim to connect with other magnets in the assembly. A stationary stator is fixed in the bore of the flywheel rim and magnet assembly in a position to intercept the said dipole field induced by the magnet assembly.

This is related to U.S. Provisional Application No. 60/317,732 filed Aug. 30, 2001 and entitled “Tubular Flywheel Energy Storage System”.

This invention pertains to compact high power flywheel energy storage systems, and more particularly to an integrated tube flywheel motor/generator and manufacturing method that has both significantly reduced cost and increased energy storage capability. The invention also provides for both increased efficiency and more simple construction with easier assembly.

### BACKGROUND OF THE INVENTION

Flywheel energy storage systems have emerged as an alternative to electrochemical batteries for storing energy, load leveling, hybrid vehicle power systems, pulsed energy sources and for prevention of power interruptions to critical loads. Electrochemical batteries used in these applications, in particular, valve regulated lead acid batteries, have many undesirable traits. The life of batteries is short, typically between 1 and 7 years depending on the environment and use. They require periodic maintenance and inspection, are subject to thermal degradation and can fail unpredictably. Moreover, lead acid batteries and other types as well are environmentally deleterious. However, lead acid batteries are relatively inexpensive. Flywheel systems show promise to eliminate the disadvantages of batteries with the expectation of achieving 20 year lives with minimal or no maintenance, temperature insensitivity, higher power capability, longer cycle life, previously unachievable reliability while being environmentally benign.

Of the many designs of flywheel systems, one particular type of flywheel energy storage system that appears to offer a promising potential has a motor/generator that is integrated into a tubular or hollow cylindrical flywheel rim which provides energy storage in the form of rotational inertia and also provides reinforcement for an array of magnets providing a flux field for a motor/generator. A schematic drawing of this type of integrated tube flywheel motor/generator system 30, shown in FIG. 1, includes a sealed container 31 that has an evacuated internal chamber 32 for reduction of aerodynamic drag on the spinning flywheel rim 33. The rim 33 is constructed of primarily hoop wound glass fiber/epoxy or carbon fiber epoxy or a combination of the two materials. The high hoop strength from hoop filament wound construction allows high-speed rotation. Inside the rim 33 are magnets 34 for a motor/generator 40. The magnets are rare earth magnets for generation of a high intensity magnetic field for maximum power capability of the system 30. The magnets 34 are arranged in a Halbach array with magnetization directions oriented about the circumference of the bore of the rim 33 as shown in FIG. 2. The Halbach array is designed to provide a high strength, highly uniform internal dipole magnetic field 53. The magnets 34 are constrained radially by the rim 33 that supports them against centrifugal loading. The mass loading from the magnets cooperates with the rim by driving it into radial compression at its inner diameter and allows for use of a radially thick rim to store more energy. The motor/generator 40 also includes a stator portion 35 that is inserted inside the bore of the array of magnets 34. Typically, three phase windings are employed for accelerating and decelerating the flywheel motor/generator 33 for storing and retrieving energy. The windings in the stator 35 can be isolated from the vacuum in the chamber 32 as shown. To support the flywheel for rotation, several types of bearing systems can be employed including mechanical and magnetic. In the system shown, mechanical bearings 39 support the rim 33 through use of a shaft 38 and the hub 41. The hub maintains connectivity with the rim 33, which grows significantly at high speed, and also maintains uniform internal loading down the length by using mass loading pieces 36 to attach the hub. The mass loading pieces 36 can be bonded in place and a radially sliding connection is formed with a central hub 37.

As shown in FIG. 2, the flywheel uses the filament wound composite rim 33 to store energy and to contain the rotating array of magnets 34 of the internal motor/generator 40. The magnets 34 have magnetic fields oriented as shown to form a strong internal dipole magnetic field 53.

The stresses in a tubular flywheel, which has a hoop wound glass fiber/epoxy rim rotating at 37 krpm and supporting an array of magnets as shown in FIGS. 1 and 2, are shown in FIGS. 3A and 3B. Glass fiber is significantly lower in cost than carbon fibers but also has lower strength and stiffness. FIG. 3A shows the radial stress distributions. The rim and magnets are driven into radial compression at their interface due to the centrifugal loading on the magnets. The compression in the rim extends part of the way through the radial thickness and becomes tensile somewhere before the radial center. The radial stress distribution is a function of the rim thickness, the dimensions of the magnets, and the rotating speed as is well know in the art. These parameters can be adjusted to keep the rim in radial compression throughout its thickness. Radial tensile strength of filament wound composites is usually very low at less than 5 to 10 ksi. The internal pressure between the magnets and rim can also become too high and cause radial compression failure of the rim. Typical hoop wound composites are usually limited to around 20 ksi. Adding off-axis fibers is typically done to increase transverse compression strengths of composites but in the case of a flywheel, this reduces the hoop strength.

The hoop stress distribution is shown in FIG. 3B. The rim is loaded from its own centrifugal loading and from the internal pressure from centrifugal loading of the magnets. Both cause the hoop stress to be greatest at the inner diameter of the rim, at 75 ksi in this case. The magnets do not theoretically have any hoop stress because they are made from pieces so they can grow with the rim. In reality, some hoop stresses exist in the individual magnet pieces from friction and bending interaction with the rim.

Use of a carbon fiber rim allows higher speed rotation and a potentially higher power motor/generator. The radial stress distribution for a tubular flywheel with carbon fiber rim rotating at 49 krpm is shown in FIG. 4A. The magnets drive the rim into radial compression at interface the same as before. The level of compression is higher due to a higher rotational speed capability. Again, the radial stress levels and distributions of the flywheel can be selected depending on the rim thickness, magnet dimensions, and operating speed. The hoop stress distribution, shown in FIG. 4B, is maximum at the inner diameter of the rim and higher than in the case with a glass fiber rim because of the higher speed.

Tubular flywheel systems with integrated motor/generators can be used to make very compact, high power energy storage systems. To date, high power flywheel systems of this type have used rare earth permanent magnets arranged in the bore of high strength, high-speed composite flywheel rims. As explained above, the internal centrifugal bore loading from the magnets is used to actually facilitate the higher speed operation of the composite rim by driving it into radial compression. The radial tensile strength of hoop wound composite rims is typically very low and would otherwise cause a failure by radial cracking if the rim experienced significant radial tension. The high hoop direction strength of the composite rim matches the high hoop direction stresses caused by rotation.

Unfortunately, integrated tube flywheel motor/generators to date have several significant drawbacks. Current systems do not store enough energy for many power quality applications. They are also very expensive partly due to the expensive magnets needed for construction. The magnets in the bore of the flywheel are assembled in an array, the Halbach array, which creates a high power dipole magnetic field in the flywheel bore using magnets with magnetic polarities oriented around the inner circumference. The special magnetization directions as well as the magnet shapes requires costly machining and waste of expensive rare earth magnet material. These magnets must also be assembled and bonded inside the rim while exerting very high forces toward each other. Another problem encountered with such systems is that the magnetic field is not completely contained inside the Halbach array and some field exists outside the rim that rotates with the rim. This high-speed rotating field causes energy loss and drag on the flywheel by its extension into the surrounding flywheel container. Other potential problems include loss of system balance due to mass shifting over time and difficulty in reliably attaching a hub to the flywheel rim due to the large internal growth coupled with the need to maintain uniform internal bore loading for prevention of excessive interlaminar shear stresses. Very high speed designs or high power designs with large bores can also become limited by radial compressive strength and or interlaminar shear strength of the composite rim.

### SUMMARY OF THE INVENTION

The invention provides an improved energy storage and retrieval system having a tubular flywheel with integrated motor/generator that is capable of storing substantially more energy than prior art designs employing glass fiber rims, and more energy even than prior art designs with costly carbon fiber rims. The magnets used in the system are also significantly lower in cost, and assembly of the magnets for the motor/generator is much easier. The invention includes a steel flywheel rim, contrary to the conventional and well accepted belief in the flywheel community that hoop wound composite flywheels store more energy than steel or metal flywheels because of their capability for higher speed operation. Composites have a higher ratio of strength to density than metals, thus allowing higher speed rotation. Since the energy is proportional to the square of the speed and is only linearly proportional to the mass, composite flywheels have been typically believed capable of storing more energy. The higher speed rotation of a composite flywheel also allows for generation of higher power by the motor/generator. Further compounding this belief is the fact that in flywheel designs that are in the form or a rim and have a central hole, the hoop direction stress in the flywheel becomes very high. The high hoop direction stress directly matches the high hoop direction strength of conventional hoop wound glass or carbon fiber composites. Adding a central hole to metal flywheel causes the hoop direction stress to double. Therefore, steel flywheels are preferably made without a central hole. Despite these facts, we have found that a steel flywheel can be used in an integrated tube flywheel motor/generator and achieve the benefits described.

The steel flywheel rim of this system has substantially higher density than a composite rim, and is manufactured by processes that enables it to be rotated safely at higher speeds than previously thought possible with steel rim flywheels. The integrated tube flywheel motor/generator of the invention rotates with tip speeds greater than 200 m/sec and preferably over 330 m/sec. The steel flywheel is made using a forged steel alloy rim with quenching and tempering processes and employing nondestructive evaluation to insure the maximum flaw size is below a certain limit. The NASGROW equation is applied to determine the crack growth life of the flywheel. Safe operation is assured by use of fracture mechanics analysis based on the maximum flaw size, steel yield strength and fracture toughness, operating stress, depth of discharge and number of cycles. Flywheels undergo an extremely low number of stress cycles throughout even a twenty-year life, due to the limited number of discharges normally experienced. Assuming a high number of cycles with a single full discharge per day, the number of cycles after twenty years is only 7300 which is orders of magnitude lower than for most mechanical systems and makes it possible to operate for many years at very high speed. Even when used in applications having a higher number of cycles, the invention provides for higher speed operation. In one embodiment, a tubular steel flywheel is designed using the NASGROW equation wherein the net section stress (using the width, w, equal to the rim length and the thickness, t, is equal to the radial thickness of the forged alloy steel rim) is greater than the yield strength. This tubular steel flywheel is designed to rotate at a speed in normal fully charged operation that is calculated to cause a failure sooner than 100,000 cycles from the speed of normal fully charged operation to 10% of that speed. Thus, the flywheel is operated at a speed so high that it would fail in less than 100,000 cycles from 100% to 10% as calculated by fracture mechanics. That does not mean that the flywheel must operate from 100% to 10%, nor does it mean that the flywheel must fail in less than 100,000 cycles. For instance, the flywheel could operate at 100% to 50% and get 200,000 cycles before failure. However, the flywheel should have an operating speed high enough such that fracture mechanics predicts a failure in less than 100,000 cycles if it were cycled between 100% and 10%.

Although the hoop stress is more than double in a tubular steel flywheel system according to this than in a solid steel flywheel operating at the same tip speed, the central hole, surprisingly, can allow the rim to achieve a higher hoop direction strength. The strength of steel is directly related to its hardness condition, which results from quenching. The ability of quenching fluid to more rapidly cool the inside of a rim flywheel allows a higher strength to be achieved. In one embodiment of the invention, the steel alloy is chosen to have an ideal critical diameter that is less than the radial thickness of the rim. This allows full hardening of the steel during the quenching process and achievement of the best properties in the final flywheel. The ideal critical diameter can be calculated using the multiplying factors of procedure ASTM A255. To achieve deep hardenability, the alloy preferably contains chromium, and molybdenum. Preferably for high toughness, the alloy steel contains more than 1.5% nickel and more than 0.65% chromium. Following quenching, tempering is done to increase the toughness. I

In one embodiment of the invention, a process for manufacturing the steel rim that allows achievement of the highest speed and energy storage is described. The rim is forged to have a predominantly hoop direction grain flow. The hoop direction is the direction of maximum stress in the rim and the fracture toughness in this direction from the process is increased. Fracture toughness which is critical to achieving the high operating speed with the invention has been found to be as much as 50% higher in the direction of grain flow than transverse direction. One method to achieving this is to forge the rim from an initial annular steel preform to a final hollow with an inner diameter that is larger than the inner diameter of the initial steel preform. A preferred method employs rolled ring forging. Hot steel stock is pierced to form a thick walled annual steel ring. The wall of the ring is then rolled between two rollers until the inner diameter of the steel ring increases a desired amount to form the material for the flywheel rim. The result is a sound material with fewer flaws and discontinuities and the rolling process increases the directional grain flow in the hoop direction. The finished flywheel preferably has an ultimate hoop tensile strength of greater than 110 ksi and a hoop direction fracture toughness of greater than 50 ksi(in)^{1/2} and more preferably more than 150 ksi and 110 ksi(in)^{1/2}.

The invention allows for both significantly reduced rim and motor/generator magnet costs. Unlike previous designs of integrated tube flywheel motor/generators, the steel rim of the invention has a high magnetic permeability and as such is a good conductor of magnetic flux. Prior composite flywheels were not good conductors of flux and thus the motor/generator magnets were required to use a Halbach array construction to achieve a high field strength. The array allowed linking of all of the magnets together but such an array is very expensive due to different pieces with different magnetization directions. The invention instead uses radially magnetized magnets than are assembled into the bore of the rim. They magnetically stick to the steel rim making assembly much easier and making use of adhesive unnecessary. With the magnets on half of the inner circumference polarized radially inward and half polarized radially outward, an internal dipole field is created. The steel rim provides a low reluctance path linking the flux between the inward and outward polarized magnets for creation of a very high intensity magnetic field. Use of a Halbach array with a steel rim would not work even if this were desirable because the steel rim would short out the field of the magnets in the array due to their magnetization directions. Although theoretically only two arc segments are required to create this field, multiple pieces, preferably 6 or more are used to prevent failure of the magnets when the flywheel rotates to high speed and the rim grows in size. To achieve the highest power motor/generator, the gaps between adjacent magnets is preferably made as small as possible to prevent loss of the internal field strength from flux simply looping around each of the individual magnets. The steel rim actually increases the efficiency of the flywheel motor/generator system over previous systems. The steel rim contains all of the flux from the motor/generator. Because the rim rotates with the magnetic field, unlike the surrounding container that contained the magnetic field in prior systems, no magnetic losses are generated. The high energy product of the magnets in combination with the magnets substantially filling the circumference of the bore, prevents changes in the magnetic field in the steel rim resulting from the changing current in the stator windings, thereby preventing rim losses caused by the stator.

As previously claimed in prior art literature, the use of the Halbach array in previous systems allowed for a uniform internal dipole field, providing the benefit of avoiding the generation of radially destabilizing forces that would make stable rotation difficult. Contrary to prior teaching, the internal magnetic field of the invention, without use of a Halbach array, the use of a large magnetic airgap from using an air core stator militates for preventing significant radially destabilizing forces. It has also been found that the invention provides a higher flux density across the inner diameter compared to an equivalent sized Halbach array. The flux density can be as much as 17% or more higher, resulting in higher power capability and a given speed.

In another embodiment of the invention, magnets are used having flat sides, thereby further reducing the costs of the motor/generator magnets. The bore of the rim can be gear cut to provide flats for placement of the magnets. However for very high speed systems, a metal magnet liner with the internal flat surfaces is interference assembled into the bore of the rim. The interference assembly reduces the hoop stresses in the liner, which has discontinuities in shape, such that the tube flywheel motor/generator can rotate to the highest speed. Use of a metal magnet liner with composite prior art flywheels would be more difficult due to their much higher radial growth. The lower radial growth of the steel rim, only 35% of a glass fiber rim and 59% of a carbon fiber rim, also facilitates easier hub attachment. Instead of requiring a polymer fiber composite hub that is likely susceptible to longer term creep failure, or attachment to separate bonded internal mass loads that can move, a metal hub liner can be interference assembled inside the bore. The magnet liner is fabricated of steel and maintains contact with the rim as it grows radially because the magnets are dense enough to drive the liner into contact with the inner circumference of the rim as the rim grows radially. Alternatively, the magnet and or hub liners can be made of a material such as manganese bronze or brass with sufficiently low ratio of modulus of elasticity to density such that it grows with the rim. Although the permeability of those materials is lower than steel, they are relatively thin and do not introduce a significant reluctance in the flux path, in the case of the magnet liner. The hub liner may be provided with an internal spline that mates with an external spline on an internal hub, thereby providing a simple and reliable flywheel hub that accounts for the rim growth.

In yet another embodiment of the invention, the ferromagnetic nature of the rim is used to form a magnetic bearing that supports the flywheel motor/generator for rotation. The large surface area on the ends of the tube allows for generation of larger magnetic forces which is especially desirable when passive radial type magnetic bearings are employed. Magnetic bearings using axially magnetized pieces in the rotor bore may be used to carry all or most of the weight of the flywheel to minimize magnetic bearing power requirements or mechanical bearing wear.

Other benefits of the invention include elimination of mass shifting in the rim over time and elimination of radial compression or interlaminar shear failures making larger diameter and higher power systems possible. The size of the motor/generator can be increased to increase the power capability and make up for a lower operating speed. The invention also has higher frequency flexural resonances, and less strain imparted to the motor/generator magnets. The invention provides several orders of magnitude lower outgassing in the vacuum containment, has a high temperature capability and requires a less stringent vacuum due to a lower operating tip speed and higher thermal conductivity of the rim, also making it safer in the event of a loss of vacuum when rotating at full speed. The lower speed can also provide for a longer bearing life if ball bearings are used for support. A lower rotational speed than prior art integrated tube flywheel motor/generators can also allow use of low cost commercially available lower frequency motor drive electronics.

### DESCRIPTION OF THE DRAWINGS

The invention and its many attendant advantages will become more clear upon reading the following description of the preferred embodiments in conjunction with the following drawings, wherein:

FIG. 1 is a schematic elevation of a prior art integrated tube flywheel motor/generator system;

FIG. 2 is a schematic plan view from one axial end of the integrated tube flywheel motor/generator shown in FIG. 1, showing a Halbach magnet array;

FIG. 3A is a plot of the radial stress distribution in an integrated tube flywheel motor/generator using a hoop wound glass fiber/epoxy rim of prior art;

FIG. 3B is a plot of the hoop stress distribution in an integrated tube flywheel motor/generator using a hoop wound glass fiber/epoxy rim of prior art;

FIG. 4A is a plot of the radial stress distribution in an integrated tube flywheel motor/generator using a hoop wound carbon fiber/epoxy rim of prior art;

FIG. 4B is a plot of the hoop stress distribution in an integrated tube flywheel motor/generator using a hoop wound carbon fiber/epoxy rim of prior art;

FIG. 5 is a schematic plan view from one axial end of an integrated tube flywheel motor/generator rotor in accordance with the invention;

FIG. 6 is a schematic plan view of an integrated tube flywheel motor/generator rotor in accordance with the invention showing the effects of magnet gaps;

FIG. 7A is a plot of the radial stress distribution in an integrated tube flywheel motor/generator using a steel rim in accordance with the invention;

FIG. 7B is a plot of the hoop stress distribution in an integrated tube flywheel motor/generator using a steel rim in accordance with the invention;

FIG. 8 is a schematic perspective view of a steel rim of the integrated tube flywheel motor/generator in accordance with the invention, illustrating flaw growth;

FIG. 9 is a plot of allowable operating stress for a 4340 steel rim of an integrated tube flywheel motor/generator in accordance with the invention, with a 10000 cycle life versus the steel ultimate strength for different discharge depths;

FIG. 10 is a plot of the allowable operating stress for a 4340 steel rim of the integrated tube flywheel motor/generator versus the steel ultimate strength for different cycle lives and discharge depths;

FIGS. 11A-11F are schematic diagrams of a seamless rolled ring forging process for manufacture of the steel rims in accordance with the invention;

FIG. 12 is a sectional plan view of a sector of a steel rim manufactured by the seamless rolled ring forging process in accordance with the invention, showing the grain flow produced by the rolling technique;

FIG. 13 is a graph showing a comparison of the energy storage of same size integrated tube flywheel motor/generators of prior art with the invention;

FIG. 14 is a graph showing a comparison of the inner diameter growth of same size integrated tube flywheel motor/generators of prior art with the invention;

FIG. 15 is a schematic plan view from one end of an integrated tube flywheel motor/generator rotor using straight-sided magnets and an internal rim liner in accordance with the invention;

FIG. 16A is a plot of the radial stress distribution in an integrated tube flywheel motor/generator using a steel rim and internal rim liner in accordance with the invention;

FIG. 16B is a plot of the hoop stress distribution in an integrated tube flywheel motor/generator using a steel rim and internal rim liner in accordance with the invention;

FIG. 17 is a schematic sectional elevation of an integrated tube flywheel motor/generator system in accordance with the invention; and

FIG. 18 is a schematic sectional elevation of an alternate configuration of an integrated tube flywheel motor/generator system in accordance with the invention.

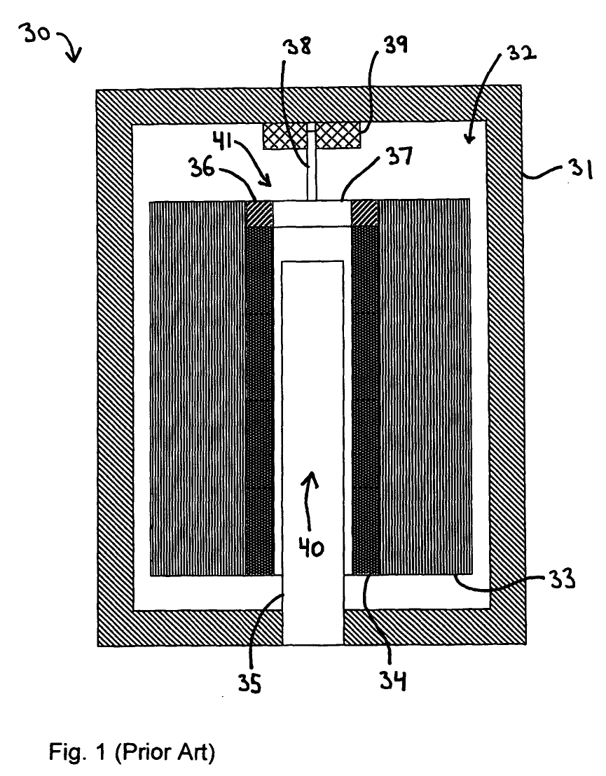

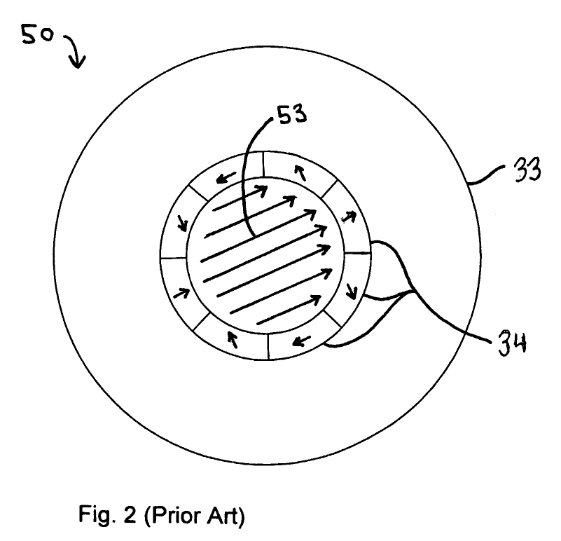

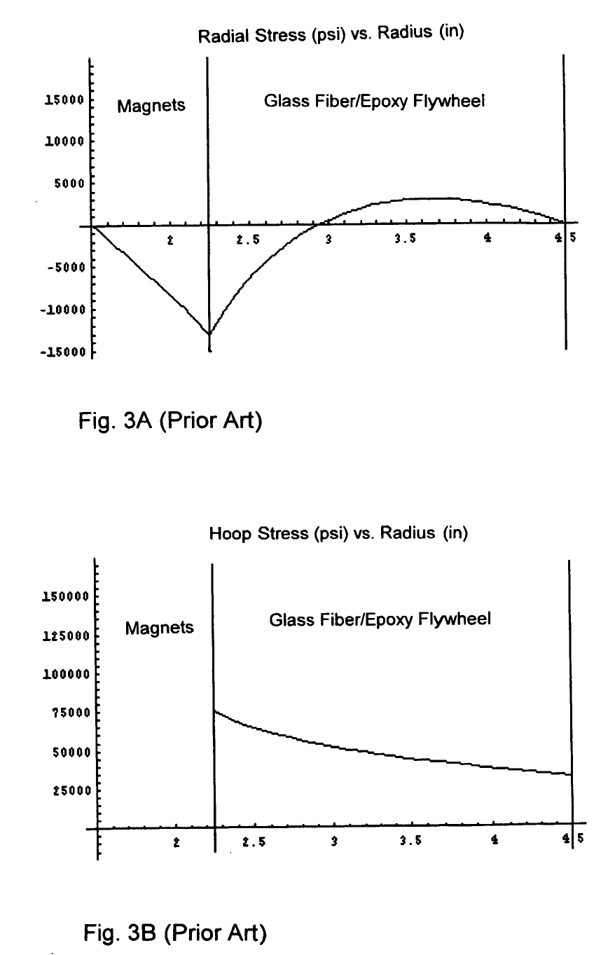

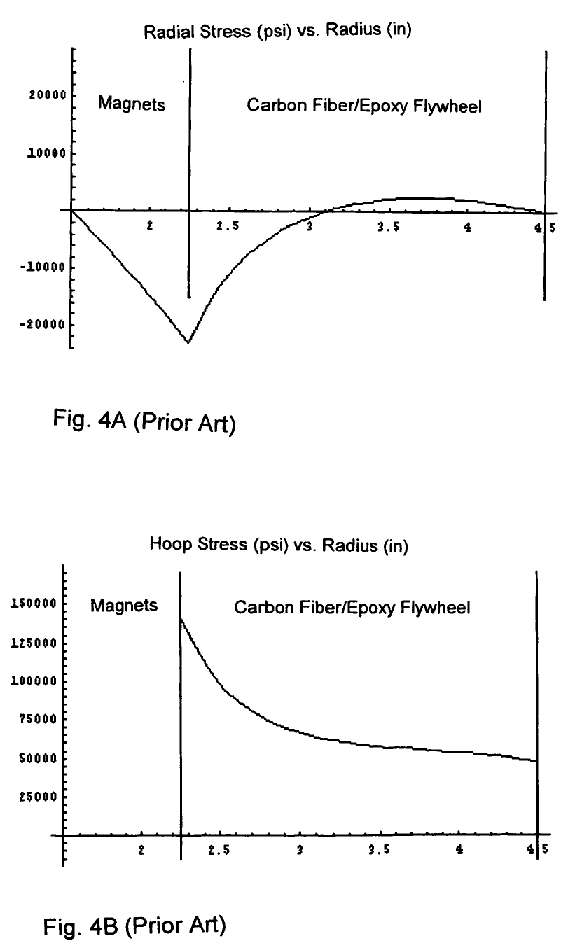

### DESCRIPTION OF THE PREFERRED EMBODIMENT

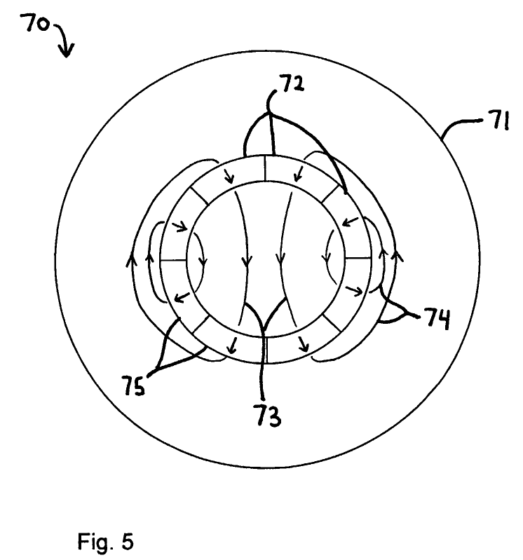

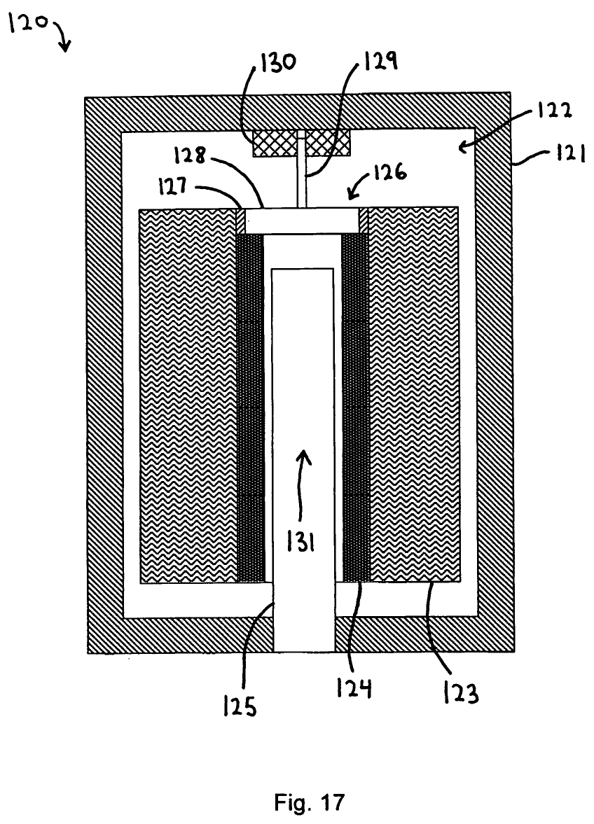

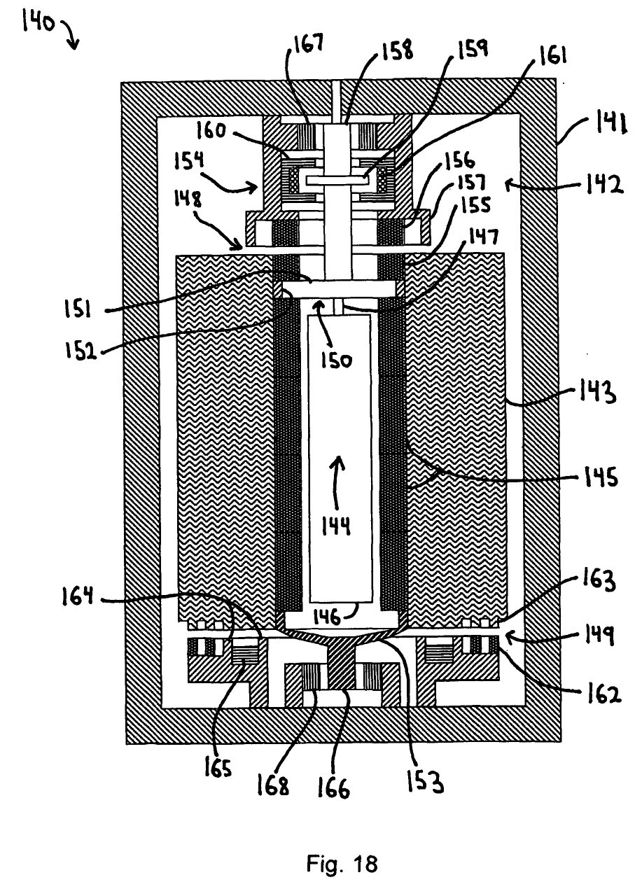

Turning to the drawings, wherein like reference characters designate identical or corresponding parts, and more particularly to FIG. 5 thereof, an integrated tubular flywheel motor/generator 70 is shown having a steel tubular flywheel rim 71 and internal motor/generator magnets 72 and 75 lining the bore of the tubular rim 71. The magnets could be as long as the flywheel but it is difficult to magnetize pieces that are over a couple of inches in length so they are preferably made from pieces comprising several axial levels of magnet rows around the inner bore, as shown in FIGS. 17 and 18. The steel rim 71 stores energy as rotational inertia, contains the motor/generator magnets 72, 75 centrifugally at the bore, and provides a low reluctance flux path to magnetically couple the magnets. The magnets are radially magnetized, with half of the magnets being radially inwardly polarized magnets 72, and the other half of the magnets being radially outwardly polarized magnets 75. Although a similar field could be established by using only two arc segment magnets, we prefer to use 6 or more magnets around the bore circumference to prevent failure in the magnets from generation of excessive hoop and bending stresses when the rim is rotated to high speed, causing it to grow radially.

Although many types of magnets could be employed, rare earth magnets and those with an energy product greater than 15 MGOe are preferred for producing the highest power in the system 70. Such magnets are usually of sintered construction and thus have a low tensile strength of only around 10 ksi. The use of multiple pieces reduces the hoop direction stresses that would be encountered during high speed rotation, with use of a higher number of pieces further reducing the stresses. The steel rim 71 provides an efficient magnetic path 74 connecting the magnets 72, 75 at the outer diameter of the assembly of magnets. This results in a very high flux density internal magnetic dipole field 73 for very high power conversion. The internal field 73 is used for accelerating and decelerating the tube flywheel motor/generator 70 for storing and retrieving energy. For an analyzed size Halbach array, the invention has been found to provide more than 17% higher magnetic flux density diametrically across the diameter perpendicular to the direction of the flux, where it increases the motor/generator power capability. A stationary stator 125, shown in FIG. 17, is inserted in the bore of the flywheel 71 concentric therewith, and the rotating flywheel and array of magnets 72, 75 rotating around the stator 125 produces a rotating magnetic field in the multiple phase windings of the stator 125 for energy conversion. The magnet pieces are much more easily assembled in the invention than prior art systems because they are magnetically attracted to the rim 71. Use of adhesives is not required. The radially magnetized pieces 72, 75 are also much lower in cost than Halbach array magnetized magnets.

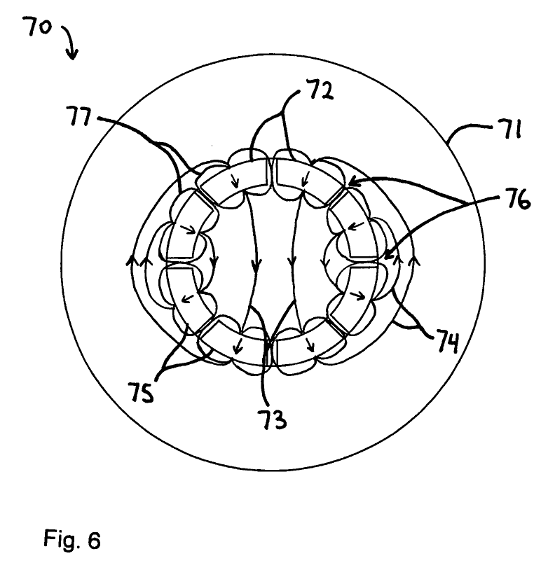

The effect of gaps between magnets 72, 75 in the array is shown in FIG. 6, greatly exaggerated for clarity of illustration. The flywheel motor/generator 70 uses the steel rim 71 with radially magnetized internal magnets 72, 75 for creation of the internal dipole magnetic field 73. Gaps between the magnets 72, 75 reduce the magnetic field created in the core by allowing a path 77 for flux to loop around between individual magnets instead of confining that flux to the core. The result is a lower flux density in the steel 74 and lower internal flux density 73. For this reason, the magnet pieces 72, 75 preferably fill most of the rim 71 bore. Some gaps will be created when spun to high speed but these are very small and result in insignificant flux leakage.

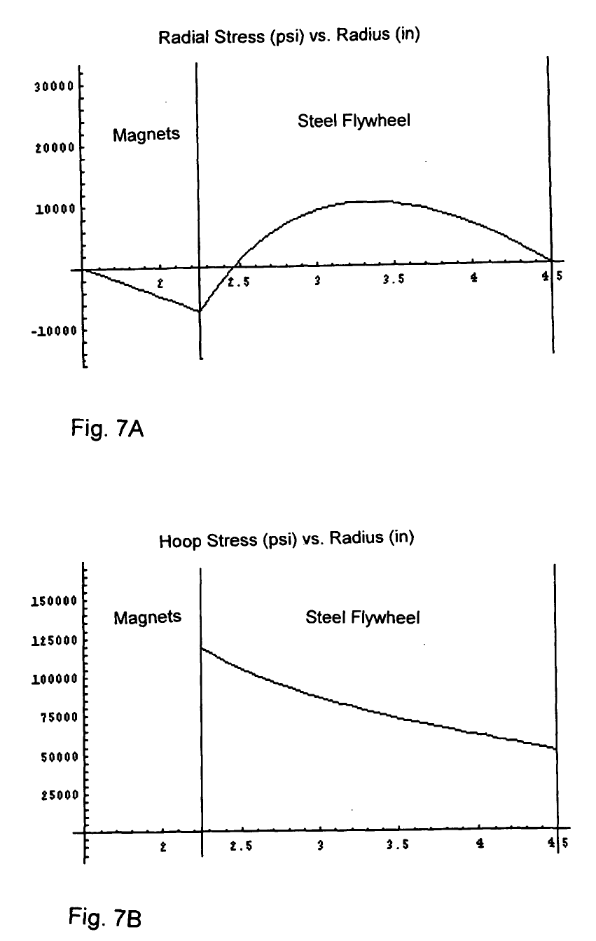

The stress distributions for a tube flywheel motor/generator in accordance with the invention are shown in FIGS. 7A and 7B. FIG. 7A shows the radial stresses. The rim 71 generates a radial tensile stress in the radial center of the cross section. The stress is higher than for a composite flywheel but much lower than the radial strength of the steel. The radial stress is compressive at the interface with the magnets due to the centrifugal loading from rotation. The radial compressive stress generated is also far below the compressive strength of steel. The hoop stress distribution is shown in FIG. 7B. The rim encounters the maximum hoop stress at the inner diameter and the hoop stress in the magnets is theoretically zero because the magnets are not connected in a continuous ring. As shown, the steel rim 71, rotating at 330 m/sec, is operating at a high stress level that is exceptionally high for steel flywheels. Hollow cylindrical steel flywheels of prior art typically rotated with maximum tip speeds of less than 200 m/sec. Operation at about 330 m/sec results in storing more than 3 times the energy per amount of steel compared to prior art designs, with a 3 times higher operating stress level.

To achieve such high speed with the invention, which allows it to store more energy than same sized composite flywheel systems of prior art, the steel rim is preferably constructed of an alloy steel, quenched and tempered and nondestructively evaluated to limit flaw sizes below a certain size. A fracture mechanical approach insures safety for the desired operating conditions and cycle life. One preferred material for the steel rim is 4340 steel because it can be deep hardened and also can be tempered to a high toughness.

Other steels with these properties could also be used, however 4340 is relatively low in cost and is widely available. Although maximum speed is achieved when using a steel flywheel if no central hole is present, surprisingly some added strength can be gained from using a tubular form. The central hole causes the hoop stress to double, halving the energy storage capability. However the central hole, which is required for placement of the motor/generator magnets, allows the center of the flywheel to be heat treated to a high strength, and also provides a central bore that offers a space for an internal roller for rolled ring rolling.

The strength of steel is directly related to its hardness condition, which is a function of the cooling rate of the steel during quenching, along with the alloy composition. Because the inner diameter of the rim is a free surface, it can be cooled much faster than the center of a solid steel round and can achieve a higher hardness and strength. After quenching, the steel is tempered to increase the toughness to the required level but with some loss in strength. The highest level of toughness and strength can be achieved when the flywheel can be fully hardened to martensitic structure throughout. To achieve full hardening, the flywheel is preferably constructed with an alloy steel that has an ideal critical diameter that is less than or equal to the radial thickness of the rim. The ideal critical diameter is the diameter of steel rounds of a particular alloy at which only 50% martensite is achieved during quenching in the radial center. Thicknesses greater than the ideal critical diameter fail to achieve optimal hardening in the center. The rate of quenching and quenching media can further reduce the depth of hardness of an alloy. One way to calculate the ideal critical diameter of steel alloys is to use the multiplying factors given in procedure ASTM A255. To achieve a high hardenability along with a high toughness desired for use with flywheels, the steel alloy preferably contains chromium and molybdenum. For high hardenability and high toughness, the steel alloy more preferably has greater than 0.65% chromium and greater than 1.5% nickel. One such commercially available alloy with reasonable costs is 4340 steel. Full hardening can be achieved for a 4340 steel rim up to several inches thick and a very high toughness can also be achieved, slowing crack growth in the fracture mechanics. The flywheel rim preferably is heat treated to a tensile yield strength above 100 ksi and a plane strain fracture toughness in the hoop direction above 70 ksi-in^{1/2}. More preferably, the rim would have a tensile yield strength greater than 140 ksi and a fracture toughness in the hoop direction greater than 100 ksi-in^{1/2}. The fracture toughness in the hoop direction is denoted for the fracture toughness that inhibits radial crack propagation from hoop stress cycling.

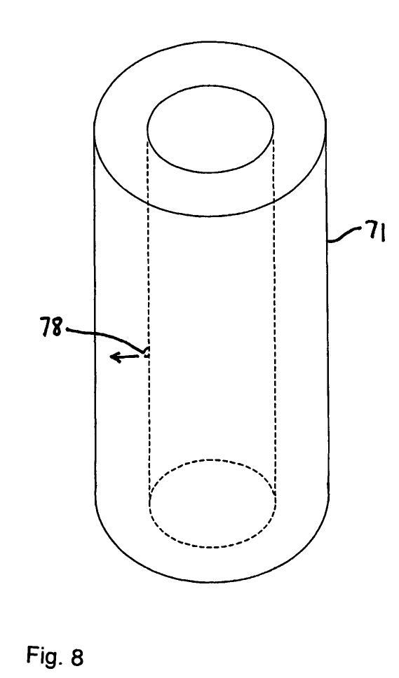

An easy solution to determine the maximum operating speed for a metal flywheel is to operate below the endurance limit of the material. Unfortunately, this results in the low operating speeds of prior art systems. Considering the very unusual nature of most flywheel energy storage systems, however, wherein the number of discharge cycles is very small even after twenty years of operation, fracture mechanics can be applied to safely increase the flywheel speed. Fracture mechanics is also applicable to increasing the operating speed for flywheels that experience a larger number of cycles, by accurately predicting the flywheels safe life. Another usually beneficial attribute with the flywheel of the invention is that the stress is principally unidirectional and the rim is never cycled, stress-wise from tension to compression, that would facilitate crack propagation. As mentioned previously, we have applied fracture mechanics to safely operate the invention at high speeds. Fracture mechanics analyzes the growth of cracks or flaws in the rim from cycling until the rim fails. In order to apply fracture mechanics, the material strength and fracture toughness must be known along with the largest flaw size in the material. The flywheel rim 71 is assumed to contain a flaw 78, shown in FIG. 8, at the worst location, which is the location of highest stress: the inner diameter. As the flywheel motor/generator is cycled, accelerating and decelerating, the crack propagates radially outward. An equation known as the NASGROW equation is used to predict the cycle life and a margin of safety that should be applied. The maximum flaw size in the material is preferably insured by using nondestructive evaluation including magnetic particle inspection and ultrasonic testing. Flaws are preferably limited to below 0.125 inches and more preferably to below 0.0625 inches, which allows high speed operation and is also used as a typical flaw detection size at reasonable cost. Certifying to smaller flaw sizes can increase the allowable operating stress level but at substantial increases in cost. Rings with flaws greater than the chosen limit are rejected. The procedure MIL Spec 2154 is preferably used for material flaw testing and certification.

The maximum flaw size allowable is used for calculation and certification. The fracture mechanics analysis is preferably done using the NASGROW equation because it allows use of one of the largest existing experimentally verified databases. A computer program called AFGROW, which was developed by the US Air Force for structural life prediction can be used to implement the NASGROW equation. The analysis bases calculations off of data from thousands of tests samples of different materials and conditions. The steps to determine the life of a part of a known material using fracture mechanics require certain factual determinations, as follows: 1) The crack length dimensions are defined by the a-dimension and c-dimension such that the hoop load is perpendicular to the direction of crack propagation. 2) The width W, defined as the length of the rotor, and the thickness t, defined as the thickness of the ring, is determined. 3.) The type of flaw must be determined. The type of flaw influences the net-section area and the stress intensity factor K, a measure of the conditions in which an existing crack in the material of a part will become unstable and grow catastrophically. 4.) To accurately determine the life of a part the stress history must be accurately known. In the case of a flywheel, the worst possible loading condition is assumed, that is, the unit will operate between the maximum operating stress and no stress.

Failure Criteria: Two different failure criteria are often simultaneously used. The first criterion is the net section failure criterion. For the embedded crack model, this criterion states that the net-section stress is equivalent to the remote applied load divided by the cross-sectional area less the area encompassed by the crack. This net-section stress is then compared to the tensile yield strength to determine whether yielding has occurred and if so the flywheel would be considered to have failed.

Stress Intensity Factor K: The second criterion compares the stress intensity factor K to a measured material property, namely the plane-strain fracture toughness K1c for a plane-strain geometrical condition. The stress intensity factor is used to determine when an existing crack will become unstable and grow catastrophically, that is, when the flywheel will fail. The stress intensity factor as developed by Newman and Raju for an embedded crack is proportional to the applied load and a complex function of the crack geometry, a and c, and the size of the part. This stress intensity factor is valid when a is less than the thickness and when the aspect ratio a/c is between 0.2 and 2.0. Using these parameters a material database can be used to predict the onset of failure.

In cases where fracture material testing data does not exist for the exact conditions that the flywheel is subject, empirical crack growth rate equations that has been extensively verified can be used. In this case, the NASGRO equation has been used.

Different elements of this equation were developed by Forman and Newman of NASA, Shivakumar of Lockheed Martin, de Koning of NLR and Henriksen of ESA and was first published by Forman and Mettu. It is given by:

$$\frac{ⅆ a}{ⅆ N} = {C [ ( \frac{1 - f}{1 - R} ) Δ K ]}^{n} \frac{{( 1 - \frac{Δ {K}_{th}}{Δ K} )}^{p}}{{( 1 - \frac{{K}_{max}}{{K}_{c}} )}^{q}}$$

where N is the number of applied fatigue cycles, a is the crack length, R is the stress ratio, ΔK is the stress intensity factor range, and C, n, p, and q are empirically derived constants. The program incorporates fatigue crack closure analysis for calculating the effect of the stress ratio on crack growth rate under constant amplitude loading. In general, if a fatigue test is run on alloy steel coupon samples with appreciable toughness (K1C>50) at a stress level just below the yield stress of the material, the coupon samples will survive for at least 50,000 to 100,000 cycles. However, to be able to safely cycle a structure near the same stress level, fracture and the internal flaws must be considered. For this reason, most steel structures are simply designed to operate well below the yield strength of the material (<50%). Non destructive evaluation or flaw size certification adds significant costs in manufacturing, however in the case of steel energy storage flywheels, these added costs are less than the cost savings by being able to store more energy. The use of the implementing crack size verification and fracture mechanics thus allows the steel flywheels of the invention to operate at much higher speeds and store significantly more energy.

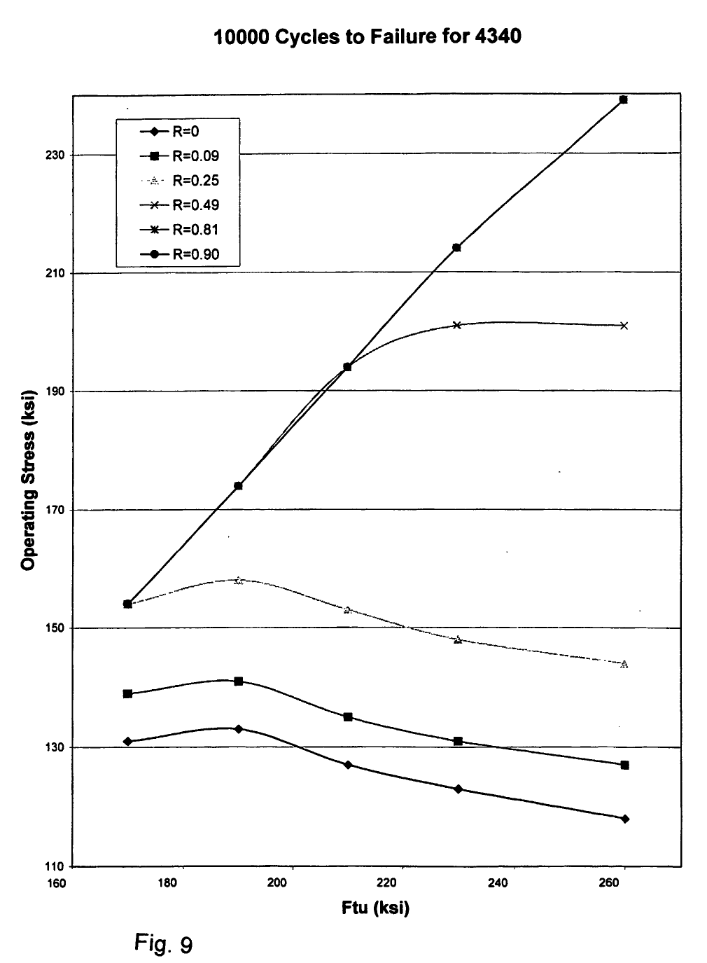

The allowable operating stress for a 4340 steel rim of the integrated tube flywheel motor/generator of the invention is shown in FIG. 9 for a 10,000 cycle life versus different strength conditions of the steel and depths of discharge. The R ratio is the minimum stress during a discharge divided by the maximum stress at normal operating speed. R=0 corresponds to discharging to stop and retrieving all of the stored energy. This is the worst case condition and hence the allowable operating stress is lowest. It is interesting to note that, when operating in the R=0 schedule, the higher the strength to which the 4340 steel is heat treated, the lower the allowable operating stress. This is due to the fact that the toughness decreases with increasing tensile strength and thus cracks can propagate more easily. The best material condition corresponds to an ultimate strength of around 190 ksi, which gives a yield strength of around 170 ksi. For the case of very low depths of discharge, R=0.9, the fracture toughness becomes less important and higher strength becomes feasible, allowing a higher operating stress. The operating stress becomes limited by the yield strength of the steel. Factors of safety should also be applied for further safety.

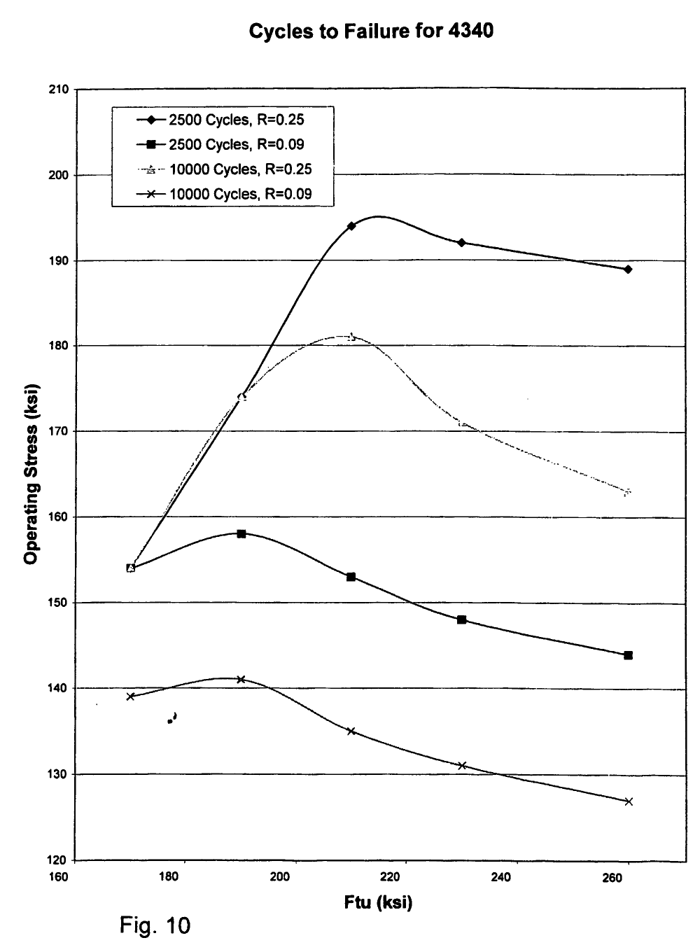

The allowable operating stress for a 4340 steel rim in accordance with the invention is shown in FIG. 10 for various likely flywheel operating conditions. Because the motor/generator loses power capability and efficiency at very low speeds, discharging flywheels to stop is a poor utilization of the flywheel's energy storage capability, and reduces its fatigue life disproportionately to the value attained by operating in that fashion. A discharge ratio (R ratio) of 0.09 removes 91% of the stored energy and a ratio of 0.25 removes 75% of the energy. Depending on the actual application for the flywheel system, cycle lives of 2,500 to 10,000 cycles can be practically sufficient. It is preferable to operate the flywheel at a stress level such that the cycle life calculated using the NASGROW equation is less than 100,000 cycles for cycles between normal fully charged operation to 10% speed. More preferably the operating speed provides a calculated cycle life of less than 50,000 cycles with R=0.1 to maximize the performance. This does not mean that the actual flywheel should operate with an R ratio of 0.1. Operating with a higher R ratio allows for a longer flywheel cycle life. For systems that have a deep discharge cycle only a few times a year, a cycle life of less than 10,000 cycles is sufficient. As with FIG. 9, the curves in FIG. 10 have a knee in the allowable operating stress versus material ultimate strength. With a 10,000 cycle life and discharge ratio of 0.25, the maximum allowable operating stress can be as high as 180 ksi. This assumes a maximum initial flaw size of 0.0625 inches. Remarkably, this can be higher than the allowable hoop stress in a carbon fiber integrated tube flywheel motor/generator, due to limitations of the simultaneously generated radial compressive and interlaminar shear stresses. Pulse power applications could use much higher cycle lives, however the fracture mechanics approach along with other embodiments of the steel rim flywheel invention can be applied to provide increased operating speed.

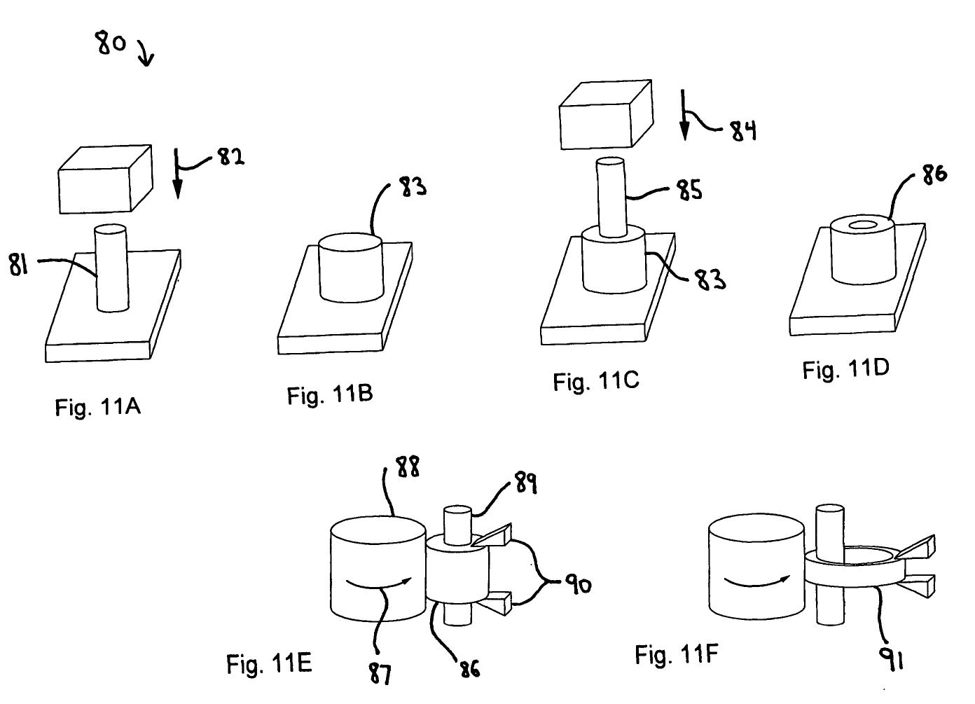

To achieve the highest possible operating speed and energy storage with the steel alloy rim flywheel, the flywheel rim is preferably manufactured by forging. Although flywheel rims could be made by casting, centrifugal casting, torch cut plate, rolling and welding or boring, we believe that forging provides the best material properties including refined grains, sound center, increased strength and toughness, and can reduce costs by elimination of material waste. Forging also provides for better response to heat treatment, more uniformity of alloys for chemical and property uniformity, and reliability. Forging that increases the grain flow particularly in the hoop direction is most preferred because it increases the hoop toughness and strength and can allow the allow rim to operate at higher speeds. One method to achieve hoop grain flow in the forged alloy steel rim is to forge to a final hollow inner diameter that is larger than the inner diameter of the initial steel perform. An embodiment using this aspect of the invention is illustrated in FIGS. 11A-11F, showing a preferred process to manufacture the flywheel rim 71 to yield reduced flaws, sounder structure and a higher hoop direction toughness than is achieved from using a cast steel tube.

The method, shown in FIGS. 11A and 11B, uses a seamless rolled ring forging or rolling process. A piece of stock steel 81 is rounded and then upset by a forge 82 or the like to produce an upset round 83 with structural integrity. As shown in FIG. 11C, the upset round 83 is then punched and pierced with a forging tool 84 and punch 85 to yield a ring 86, shown in FIG. 11D. The ring 86 is then hot rolled between idler and drive rolls 87 and 89 under radial pressure. Axial rolls 90 can be used to control the height. The radial pressure during the ring rolling forging process causes predominantly hoop directional grain flow, causing the ring to grow in diameter to the desired wall thickness and diameter, as shown in FIG. 11F. The hoop directional grain flow specially matches the hoop stress of the flywheel rim. The result of the hoop directional grain flow is a high fracture toughness resisting crack propagation from hoop stresses. The fracture toughness in the direction of grain flow in steel has been measured as much as 50% higher than the transverse direction. The higher toughness in the needed direction allows significantly increased operating stress levels in the rim.

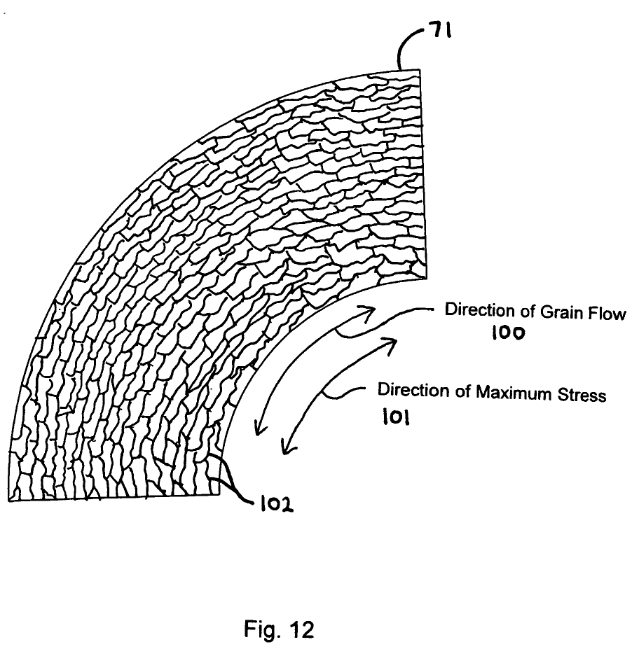

FIG. 12 illustrates the grain flow and operating stress direction of the ring-rolled ring 71 made by the process shown in FIGS. 11A-F. The flywheel rim 71 has grains 102 that are predominately elongated in the hoop direction from the hoop direction of grain flow 100 during rolling, and this matches the high hoop operating stresses 101. The use of the steel alloy rim technology disclosed and of seamless rolled ring forging for manufacture of steel flywheel rings can also be used for manufacturing steel ring flywheel systems of other configurations with other motor/generators types.

Another forging process that also produces minimized grain flow in the radial direction is tube mandrel forging. This can also be applied but with less hoop direction flow and more axial flow. As with seamless rolled ring forging, the radial direction has the least flow and matches the low radial tensile stresses in the operating rim flywheel. Fracture toughness testing of a forged 4340 steel flywheel that was quenched and subsequently tempered at 950° F. revealed a plane strain fracture toughness of 85 ksi-in^{1/2} perpendicular to the direction of the grain elongation and a toughness of 121 ksi-in^{1/2} parallel to the direction of grain elongation. The higher hoop direction toughness allows a higher operating stress capability in the hoop direction than the radial direction. This is similar to commonly employed hoop wound fiber composite flywheels and the higher hoop stress capability matches the higher hoop stress encountered in a rotating ring.

The high stress capability of the steel flywheel ring of the invention can allow it to be substituted as a direct replacement for composite flywheels of many system designs. The benefits include less growth for easier hub connection, lower vacuum outgassing and lower cost, with the possible drawbacks of reduced energy storage per weight. For composite flywheel systems that weigh several hundred pounds, the increased weight of the rim can be an insignificant factor.

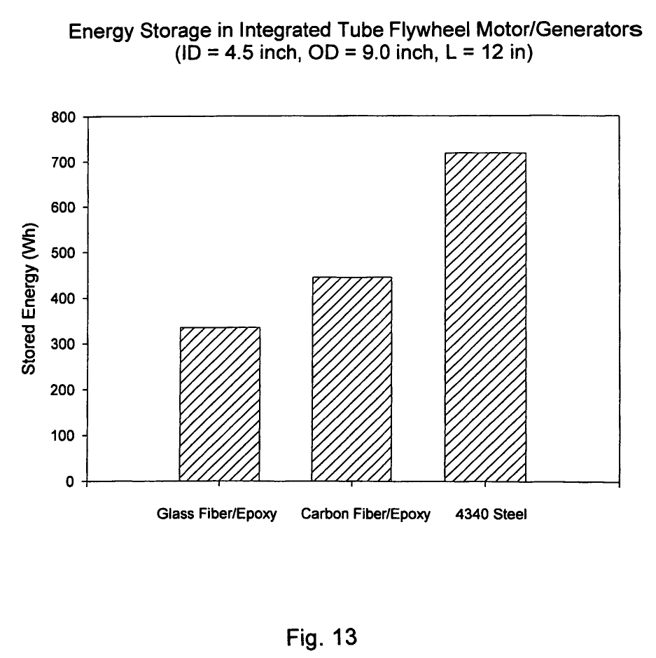

The invention provides increased energy storage over prior art integrated tube flywheel motor/generators using composite flywheels with Halbach array motor/generators. A comparison of the energy storage of three identically sized flywheel motor/generators operating at their respective allowable speeds (37 krpm, 49, krpm, 28 krpm) is given in FIG. 13. Although the invention rotates slower than the composite flywheel designs, the stored energy is greater due to the higher density. The steel rim design stores more than twice the energy of the glass fiber system and 60% more energy than the carbon fiber design.

The invention also makes possible a flywheel energy storage system having a flywheel with significantly less inner diameter growth from rotating at operating speed.

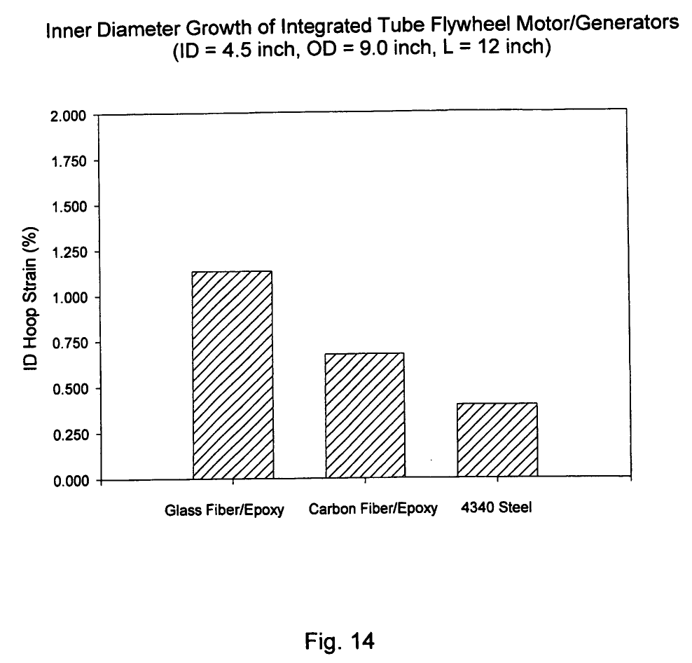

As illustrated in FIG. 14, the steel rim grows less than half that of the glass fiber integrated tube flywheel motor/generator and 40% less than the carbon fiber integrated tube flywheel motor/generator. The lower growth allows for an easier hub attachment and minimizes the growth of gaps between the magnets 72, 75.

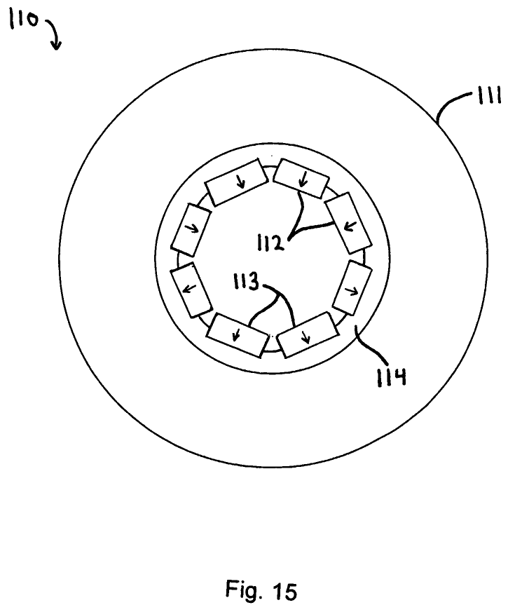

In another embodiment of the invention, the cost of the motor/generator magnets can be even further reduced by making the magnets with flat sides facing the rim and even in the shapes of rectangles, as illustrated in FIG. 15. The inner bore of the rim is machined or gear cut to provide flat surfaces for the magnets. The high multidirectional strength of the rim can account for the internal bore surface discontinuities. However for increased strength, an internal magnet liner can be used. The integrated tube flywheel motor/generator 110 is comprised of a steel rim 111 and flat-sided radially magnetized magnets 112 and 113. The magnets are held in a magnet liner 114 preferably constructed of metal for high multidirectional strength. The magnet liner 114 is interference assembled into the bore of the rim 111. The benefit of using a magnet liner is that the interference assembly drives it into hoop compression at zero speed and keeps it at a substantially lower stress level at operating speed. The magnet liner can be made of steel for high magnetic permeability or if sufficiently radially thin, other non-ferrous metals could be used with the benefit of a higher thermal expansion for assembly. To minimize flux leakage, trapezoidal magnets could be used instead of the rectangular magnets shown, or the inner corners of the rectangular magnets could have very small gaps.

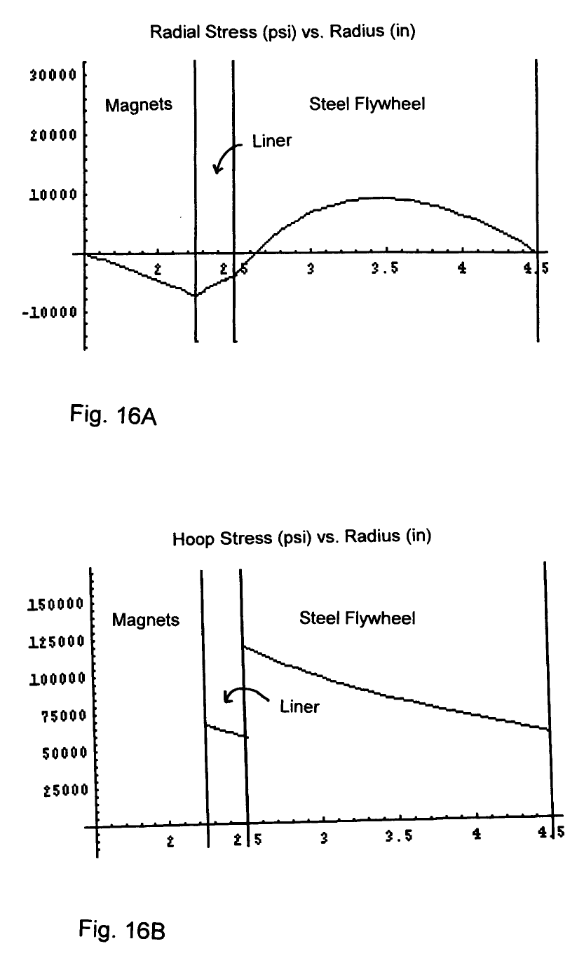

The stress distributions in an integrated tube flywheel motor/generator with internal magnet liner in accordance with the invention are shown in FIGS. 16A and 16B. In this case, the magnet liner is constructed of steel. The radial stress distribution is only slightly changed from the design without a liner. The hoop stress in the magnets is theoretically zero and the hoop stress in the rim is highest it its inner diameter as before. The magnet liner however, has substantially reduced hoop stress due to the interference assembly. The magnet liner insures that the discontinuities required at the bore for using straight sided magnets do not cause the rim to fail and the lower hoop stress in the magnet liner from the interference assembly with the rim prevents the liner from failing.

A complete integrated tube flywheel motor/generator system in accordance with the invention is shown in FIG. 17. The system 120 uses a steel flywheel rim 123 that is housed inside an outer vessel 121 with an evacuated internal chamber 122. The rim 123 contains an internal motor/generator 131 that uses preferably 6 or more radially magnetized magnet pieces 124 around the circumference of the bore. Several axial levels of magnets 124 can be used to fill the length of the rim bore, arranged as shown in FIGS. 5 or 15. A stationary stator 125 is fixed in the floor of the vessel 121 and can be isolated from the vacuum in the chamber 122 to simplify maintenance of the vacuum in the chamber 122 and cooling of the stator coils. The stator 125 includes multiple phase windings, not shown, which are preferably air core for reduced inductance and instantaneous supply of power when needed. The windings are also preferably constructed from multiple strand individually insulated conductor (Litz) wire to reduce losses from eddy currents. The magnetic field from the magnets 124 loop around the circumference through the rim 123 to increase the magnetic flux density in the center. The rotating steel flywheel rim also contains the rotating magnetic field so that no field extends out to the metal container 121 which would cause losses. The illustrated motor generator 131 is preferred because of its ease of manufacture, high efficiency and low cost, but other brushless motor generators could also be used with the steel flywheel to obtain the benefits provided thereby while offering different trade-offs, for example, even lower cost at the expense of lower efficiency.

Because of the lower growth of the rim with the invention, a hub 126 can be attached multiple ways. As shown, the hub 126 uses an inner piece 128 and an outer piece 127. The low growth of the rim allows the outer piece 127 to be constructed of a single continuous metal hub liner that can grow with the rim. The outer piece (hub liner) 127 is preferably made from a material that it can grow with the rim and is supported by the rim. These properties would be provided by a material with ratio of modulus of elasticity in GPa to density in kg/m³ of less than 0.02, such as non-ferrous metals with densities greater than 5000 kg/m³ such as brass and manganese bronze, the latter of which is preferred for high strength. The inner piece can be made of steel or many different things. The outer piece 127 has a radially inward protruding surface such as a spline. This surface, not shown, mates with a radially outward protruding surface or spline on the inner hub portion 128. The result is a radially sliding connection that is low cost, easy to assemble and more reliable than using individual mass load pieces or a polymer fiber composite hub. The hub 126 can then be attached to a shaft 129 and a mechanical bearing 130.

Another integrated tube flywheel motor/generator system 140, shown in FIG. 18, demonstrates several different combinations of possible attributes. The system 140 uses a flywheel with a steel rim 143 that rotates inside a container 141 with an evacuated internal chamber 142. An array of radially magnetized magnets 145 generate a high power dipole field in the core of the flywheel, as illustrated in FIGS. 5 or 15, where a stationary stator 146 of an internal motor/generator 144 is mounted to the container 141 using a shaft 147. The motor/generator stator 146 provides the electromechanical energy conversion by accelerating and decelerating the magnets 145 and rim 143. In this configuration of the invention, the flywheel motor/generator is supported for rotation using magnetic bearings 148, 149, 154. Yet another aspect of the invention is illustrated, which includes using the rim as part of the magnetic bearings and building the magnetic bearing into bore ends of the rim. The magnetic bearing 149 is a passive radial type with active axial control. This magnetic bearing uses centering grooves 163 cut into the axial face of the rim 143. These grooves generate passive radial magnetic centering by tending to align with stationary permanent magnet rings 162.

An active axial downward force control is provided by an annular electromagnetic coil 165 and two steel poles 164 that also act on the end of the rim. The large surface area of the rim ends allows for generation of large forces and is also useful with passive radial magnetic bearings. On the upper end, two other types of magnetic bearings are shown. In one embodiment of the invention, the magnetic bearing 148 works by placing axially magnetized magnet pieces 147 into the bore end of the rim 143. The preferably 6 or more pieces 155 are reinforced by the rim and provide a strong passive radial centering force and axial force in cooperation with stationary facing axially magnetized magnets 156. The rim 143 can again be used for the flux return path along with steel pole 157. The invention could also be supported by more conventional magnetic bearing approaches that include an active magnetic bearing 154 acting on the flywheel shaft 158. The upper shaft 158 is attached to the rim using a hub 150 with inner and outer radially sliding hub pieces 151 and 152. A magnetic bearing rotor 159 is attached to the shaft 158 and acted upon by the magnetic bearing stator 160 and coils 161. During loss of magnetic bearing function, an upper auxiliary bearing 167 prevents damage to the system. On the lower end, a bell type hub 153 is shown for attaching the rim 143 to a lower shaft 166. The shaft 166 contacts a lower auxiliary bearing 168 in the event of loss of magnetic bearing function.

Obviously, numerous modifications and variations of the preferred embodiment described above are possible and will become apparent to those skilled in the art in light of this specification. Different attributes of all of the different disclosed configurations can be interchanged and are not intended to be exclusive for use with the other elements and attributes of a particular system configuration. Many functions and advantages are described for the disclosed preferred embodiments, but in many uses of the invention, not all of these functions and advantages would be needed. Therefore, we contemplate the use of the invention using alternate or fewer than the complete set of noted components, features, benefits, functions and advantages. Moreover, several species and embodiments of the invention are disclosed herein, but not all are specifically claimed, although it is intended that all be covered by generic claims. Therefore, it is our intention that each and every one of these species and embodiments, and the equivalents thereof, be encompassed and protected within the scope of the following claims, and no dedication to the public is intended by virtue of the lack of claims specific to any individual species. Accordingly, it is expressly intended that all these embodiments, species, modifications and variations, and the equivalents thereof, are to be considered within the spirit and scope of the invention as defined in the following claims, wherein we claim:

1. A flywheel energy storage system comprising:
a steel flywheel that is supported for rotation about an axis inside a low pressure container by a bearing system;
said steel flywheel having an operatively attached motor and generator for accelerating and decelerating said steel flywheel for storing and retrieving energy;
said steel flywheel being constructed from a forged alloy steel rim having a hollow inner diameter and an outer diameter wherein said steel flywheel rotates with an outer diameter peripheral speed that is greater than 200 m/sec in normally fully charged operation of said flywheel energy storage system.

2. A flywheel energy storage system as described in claim 1 wherein:
said forged alloy steel rim is forged with grain flow that is predominantly in the hoop direction.

3. A flywheel energy storage system as described in claim 2 wherein:
said forged alloy steel rim is forged by using rolled ring forging.

4. A flywheel energy storage system as described in claim 1 wherein:
said forged alloy steel rim is forged to a final hollow inner diameter that is larger than the inner diameter of the initial steel perform.

5. A flywheel energy storage system as described in claim 1 wherein:
said forged alloy steel rim is forged to have a minimum direction of grain flow that is radial.

6. A flywheel energy storage system as described in claim 1 wherein:
said forged alloy steel rim is constructed with a steel alloy that has an ideal critical diameter that is greater than the radial thickness of said forged alloy steel rim.

7. A flywheel energy storage system as described in claim 6 wherein:
said steel alloy is an alloy containing chromium and molybdenum.

8. A flywheel energy storage system as described in claim 7 wherein:
said steel alloy contains more than 1.5% nickel and more than 0.65% chromium.

9. A flywheel energy storage system as described in claim 1 wherein:
said forged alloy steel rim is constructed from steel with both a hoop direction ultimate tensile strength greater than 110 ksi and a hoop direction toughness greater than 50 ksi (in)^{1/2}.

10. A flywheel energy storage system as described in claim 9 wherein:
said forged alloy steel rim is constructed from steel with both a hoop direction ultimate tensile strength greater than 150 ksi and a hoop direction toughness greater than 110 ksi (in)^{1/2}.

11. A flywheel energy storage system as described in claim 1 wherein:
said forged alloy steel rim rotates at a speed in normal fully charged operation that is calculated to cause a failure by use of the NASGROW equation wherein the net section stress using the width, w, equal to the rim length and the thickness, t, equal to the radial thickness of said forged alloy steel rim is greater than the yield strength in under 100,000 cycles from the speed of normal fully charged operation to 10% of said speed.

12. A flywheel energy storage system as described in claim 111 wherein:
said failure is calculated to occur in less than 50,000 cycles.

13. A flywheel energy storage system as described in claim 1 wherein:
said forged alloy steel rim rotates at a speed in normal fully charged operation that is calculated to cause a failure by use of the NASGROW equation wherein the stress intensity exceeds the plain strain fracture toughness in less than 100,0000 cycles from normal full speed to 10% speed.

14. A flywheel energy storage system as described in claim 13 wherein:
the failure is calculated to occur in less than 50,000 cycles.

15. A flywheel energy storage system as described in claim 1 wherein:
said forged alloy steel rim is ultrasonically inspected for flaws prior to being put in to service and is rejected if flaws are detected with length greater than 1/8^{th} inch.

16. A flywheel energy storage system as described in claim 1 wherein:
said forged alloy steel rim rotates at an operating speed in normal fully charged operation and has a maximum allowable initial flaw size as verified by nondestructive evaluation such that fracture mechanics analysis predicts that said forged alloy steel rim will not have a fracture failure from a radial propagating crack during the expected operating life of said flywheel energy storage system.

17. (canceled).

18. An integrated flywheel motor/generator that spins about an axis inside an evacuated chamber for storing and retrieving energy, comprising:
a hollow cylindrical steel rim with an assembly of permanent magnet pieces substantially filling the circumference of the inner diameter and defining a magnet-lined bore, wherein said magnet pieces are radially magnetized and said assembly forms a dipole field across said magnet-lined bore of said assembly with magnetic flux traveling from the outer diameter of said magnets in the assembly through the steel rim to connect with other magnets in said assembly;
said magnetic pieces number six or more pieces around the circumference of the steel rim inner diameter; and
a stator in said bore of said dipole field, said stator comprising windings.

19. An integrated flywheel motor/generator as described in claim 18 wherein:
said hollow cylindrical steel rim rotates with an outer diameter peripheral speed that is greater than 200 m/sec in normally fully charged operation.

20. (canceled).

21. (canceled).

22. (canceled).

19. (canceled).

20. (canceled).

21. (canceled).

22. (canceled).

23. An integrated flywheel motor/generator that spins about an axis inside an evacuated chamber for storing and retrieving energy, comprising:
a hollow cylindrical steel rim with an assembly of permanent magnet pieces substantially filling the circumference of the inner diameter, wherein said magnet pieces are radially magnetized and said assembly forms a magnetic field in the inner diameter of the assembly of magnets with magnetic flux traveling from the outer diameter of said magnets in the assembly through the steel rim to connect with other magnets in said assembly;
said magnet pieces number six or more pieces around the circumference of the steel rim inner diameter;
said steel rim is connected to a shaft through use of a multiple piece hub;
said hub is comprised of a hub liner that is held with radial interference with said rim and has radially inward protruding appendages;
said hub liner is constructed from a material with a ratio X of hoop direction modulus of elasticity measured in GPa divided by density measured in kg/m\hat{ }3, wherein x is less than 0.02;
said hub also being comprised of an inner portion with mating radially outward protruding appendages so as to provide a radially sliding connection that maintains substantial concentricity between said inner portion and said rim.

24. An integrated flywheel motor/generator as described in claim 23 wherein:
said radially sliding connection of said hub is formed by an internal spline on the hub liner inner diameter and an outward spline on the hub inner portion.

25. (canceled).

26. (canceled).
